(19) United States
(12) Patent Application Publication
(10) Pub. No.: US 2014/0209526 A1
(43) Pub. Date: Jul. 31, 2014

(54) DUAL STAGE BIOREACTOR SYSTEM FOR REMOVING SELENIUM FROM WATER

(71) Applicants: Timothy Michael Pickett, San Diego, CA (US); James John Peterson, San Diego, CA (US)

(72) Inventors: Timothy Michael Pickett, San Diego, CA (US); James John Peterson, San Diego, CA (US)

(21) Appl. No.: 13/803,904

(22) Filed: Mar. 14, 2013

Related U.S. Application Data
(60) Provisional application No. 61/757,689, filed on Jan. 28, 2013.

(51) Int. Cl. C02F 3/28; C02F 1/44

(52) U.S. Cl. CPC C02F 3/286; C02F 1/444; C02F 3/2833; C02F 1/441; C02F 1/442
USPC 210/259; 210/252

(57) ABSTRACT

The present invention provides, in at least one embodiment, an upflow bioreactor removes trapped gases within the bed that effect water flow and a downflow bioreactor removes carbonaceous compounds and retains the particulate elemental selenium. The system integrates biological selenium reduction with biological filtration (via the downflow bioreactor) and an optional membrane filtration. The membrane filtration removes residual selenium and other particulate matter, which would get into the effluent. In one embodiment, the novelty of the invention is the utilization of an upflow bioreactor followed by a downflow bioreactor applied to selenium removal.

### BACKGROUND OF THE INVENTION

1. Field of Invention

The invention relates generally to a water treatment process to remove dissolved contaminants from water, and more particularly, to a process for removing selenium from selenium-containing water.

2. Description of Related Art

Selenium is a chemical element with the symbol Se and the atomic number 34. Anthropogenic sources of selenium and selenium compounds include mining, coal fired power plants, agricultural drainage, oil refining, and natural gas extraction. Selenium in small amounts is an essential nutrient for fish and other wildlife, but at high levels, is toxic for the fish and the other wildlife.

Various human industrial activities produce wastewater streams containing high levels of selenium that are toxic for fish or other wildlife. As such, water treatment processes are often applied to remove selenium compounds prior to discharge into the environment. The United States Environmental Protection Agency (EPA) has a recommended water quality criteria for selenium of 5 micrograms per liter. In the near future, the EPA is expected to enact strict regulations regarding the amount of selenium that may be discharged into the environment through wastewater.

Various conventional processes have been employed for selenium removal from water. Three conventional processes include iron co-precipitation, activated alumina treatment, and biological treatment. Biological treatment has emerged as the most promising of these three conventional processes, partly because biological treatment is an economical means of removing of selenium from water. In biological treatment, contaminated water is treated using a bioreactor system.

One biological treatment solution to remove selenium is selenium treatment. In selenium treatment, a conventional bioreactor system turns soluble selenium (also referred to as dissolved selenium) into particulate elemental selenium.

The soluble selenium can be a dissolved, oxidized form of soluble selenium (e.g., selenate SeO₄²⁻ and selenite SeO₃²⁻) The particulate elemental selenium is formed via bacterial selenium reduction within the bioreactor, which converts the soluble oxidized forms of selenium to insoluble particles of elemental selenium precipitate. Particulate elemental selenium may also be referred to as fine elemental selenium particles, reduced elemental selenium particles, or an elemental selenium precipitate, where the precipitate is a substance in solid form that is separated from a solution.

Conventional biological bioreactor systems for water treatment include suspended growth bioreactors, fixed bed bioreactors, and fluidized bed bioreactors. A fixed bed bioreactor can also be referred to as a packed bed bioreactor. Both fixed bed bioreactors and fluidized bed bioreactors use an insoluble support media to remove contaminants from water. The support media is referred to as being insoluble, meaning that it is incapable of being dissolved. The conventional insoluble support media can be granular activated carbon (GAC), sand, or another media. This media is used provide surface area for bacteria to colonize as a biofilm.

Conventional fixed bed bioreactors tend to be large in size due to low hydraulic loading requirements required for solids retention and can have problems with gas retention in the bed. Fluidized bed bioreactors, overcome the gas retention problems due to their media expansion. These systems show promise for effective selenium reduction in a smaller footprint, but have issues with particulate selenium retention.

A biofilm (also referred to as a bacteria biofilm, active biofilm, etc.) is a complex structure such as colonies of bacteria and other microorganisms (e.g., yeasts, fungi, etc.). The complex structure adheres to support media that is regularly in contact with water.

The biofilm is effective in reacting with water to remove contaminants from the water. Thus, the bioreactor system passes water through the biofilm, and when the water comes into contact with the biofilm, the biofilm reacts with the contaminants and removes the contaminants from the water. The biofilm is created from the bacteria on the insoluble support media. The biofilm will precipitate (i.e., separate) the dissolved selenium, as small (<1 uM), into elemental selenium particles. Bioreactor systems biologically reduce the soluble selenium into larger particles of elemental selenium, which enable the selenium to be retained within the bioreactor system. However, conventional bioreactor systems struggle with retaining the fine particulate selenium. Conventional bioreactor systems also have issues with gas retention which impact bed permeability and impede water flow through the system, and may not completely consume the carbon nutrient that is fed to the system.

The biofilm is formed from bacteria that consume carbohydrate nutrients, which are supplied to the system. The carbohydrate nutrients stimulate the growth and respiration of the biofilm. However, as biological systems are fed a carbohydrate nutrient, that carbohydrate nutrient may not be completely consumed by the selenium removal bioreactor. Also, as bacterial respiration creates gas such as carbon dioxide, nitrogen, and hydrogen sulfide. In conventional systems, these gases must be periodically released from the bed.

The consumption of the carbohydrate nutrient may create carbonaceous compounds and organic particulate matter, which can get in the effluent, reducing water quality. The effluent is the output/exit of the bioreactor system, typically going to a river, lake, or stream. The carbonaceous compounds may be referred to, or quantified as, Chemical Oxygen Demand (COD) or Biological Oxygen Demand (BOD).

These conventional bioreactor systems and processes fall short in three areas of concern that affect the quality of the effluent. The first relates to retaining the particulate elemental selenium. The second relates to removing the trapped gases within the bed that effect water flow. The third relates to removing the contribution of carbonaceous compounds in the effluent. Conventional processes do not effectively retain these, and allow a residual amount escape into the treated clean water effluent that is exited out of the bioreactor system. The dual bioreactor system and method of the present invention resolves all of these areas of concern.

### SUMMARY OF THE INVENTION

The present invention provides, in at least one embodiment, a multi-stage water treatment system which receives water containing soluble selenium, and precipitates this soluble selenium to form filterable selenium, which is easier to remove than soluble (dissolved) selenium as the water passes through the system. Filterable selenium is also referred to as particulate selenium, solid selenium, or precipitate. Filterable selenium is comprised of larger particles, not a molecular, dissolved form, and therefore can be filtered.

In one embodiment, a system comprises: an upflow bioreactor having a bed, the upflow reactor configured to precipitate, concentrate, and biologically reduce dissolved selenium from water, wherein the water flows upwards in the upflow bioreactor, wherein the upward flow of water removes trapped gasses from the bed, wherein the upflow bioreactor creates carbonaceous compounds and particulate selenium in the water; and a downflow bioreactor coupled to the upflow bioreactor, the downflow bioreactor configured to filter the carbonaceous compounds and configured to filter the particulate selenium. The system may further comprise a membrane filtration configured to filter a residual particulate selenium remaining after the downflow bioreactor. The membrane filtration may comprise microfiltration, ultrafiltration, reverse osmosis, or nanofiltration. The system may further comprising a solids handling step coupled to the downflow bioreactor, wherein the solids handling step is configured to separate solids from water. The system may further comprise a feed water source coupled to an input of the upflow bioreactor. The water may flow downwards in the downflow bioreactor.

Unlike conventional systems, an upflow bioreactor removes trapped gases within the bed that effect water flow and a downflow bioreactor removes carbonaceous compounds and retains the particulate elemental selenium. The system integrates biological selenium reduction with biological filtration (via the downflow bioreactor) and an optional membrane filtration. The membrane filtration removes residual selenium and other particulate matter, which would get into the effluent. In one embodiment, the novelty of the invention is the utilization of an upflow bioreactor followed by a downflow bioreactor applied to selenium removal.

The biological selenium reduction (in the upflow bioreactor) may remove some selenium. The upflow system keeps the bed in an expanded mode, thereby liberating any gas to be expelled out of the top of the bed. The bed will also expel particulate selenium, but this will be collected in the second stage (i.e., the downflow bioreactor). An advantage of the upflow bioreactor flow going “up” is that this promotes better gas removal, as the gas is carried up and through the expanded bed as the expanded bed forms.

The downflow second stage is a packed bed bioreactor designed to further reduce any soluble selenium, and filter any particulate selenium created by the first stage. The second stage also consumes any residual nutrient that carries over from the first stage. This novel configuration results in the production of a high quality water stream for discharge or release into the environment. An advantage of the downflow bioreactor flow going “down” through a packed bed is better solids retention.

In addition to selenium precipitation in the upflow bioreactor and particulate selenium capture in the downflow biofilter, the invention provides complete particulate retention with the downstream membrane filtration. This results in a removal of selenium, biochemical oxygen demand (BOD)/chemical oxygen demand (COD), and retention of residual particulate selenium particles.

A main advantage of the present invention is creating high quality water by decoupling the selenium reduction and solids removal, while polishing the water for residual COD/BOD removal. The filterable selenium is created by the upflow bioreactor. The filterable selenium can be filtered by a downflow bioreactor, improving the performance of the bioreactor system, and producing high quality water effluent. The effluent water is suitable for direct discharge into live streams which area occupied by fish and accessible by other wildlife habitat. The downflow bioreactor may be followed by an additional membrane filtration step for further polishing of the water.

Another advantage of the invention includes contaminant removal ultra-low levels of <5 ug/L total selenium by the filtration of fine particulate selenium. In conventional selenium treatment bioreactors, the particulate selenium can escape the bed and contribute to selenium in the effluent. These components allow for discharge of a high quality effluent stream suitable for direct discharge.

A further advantage of the invention includes a smaller footprint. The smaller footprint is achievable because as solids retention is decoupled from the bioreactor and is in the downflow bioreactor. As a result, the bioreactor can be downsized compared to conventional approaches which require a deep bed and long contact time to achieve both selenium precipitation and solids retention.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a multi-step system for selenium removal according to an embodiment of the invention;

FIG. 2 illustrates the feed water source of FIG. 1 according to an embodiment of the invention;

FIG. 3 illustrates the upflow bioreactor of FIG. 1 according to an embodiment of the invention; and

FIG. 4 illustrates the process of using the system according to an embodiment of the invention.

### DETAILED DESCRIPTION OF EMBODIMENTS

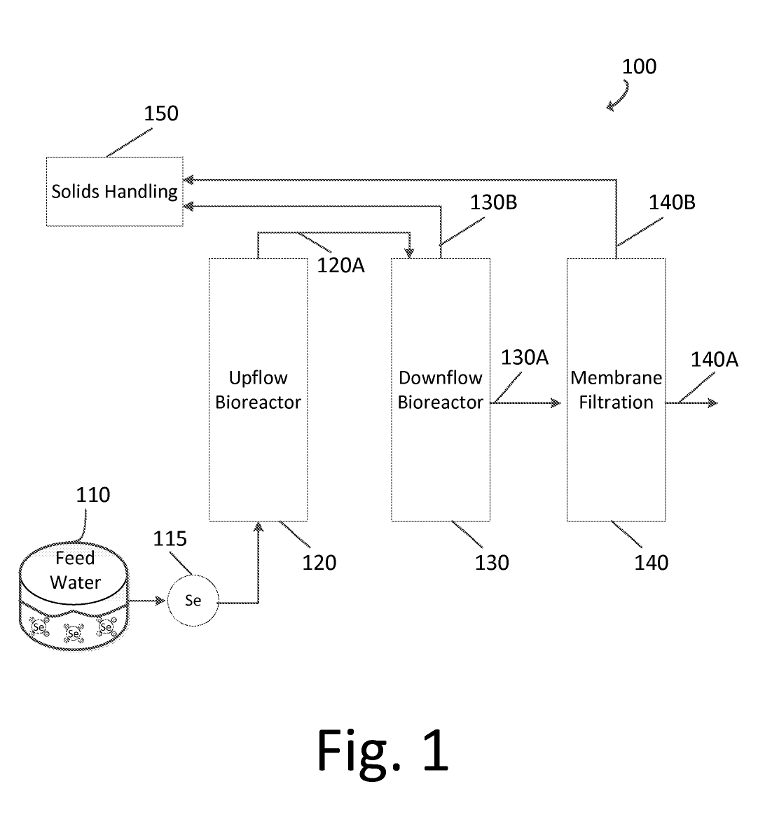

Further features and advantages of the invention, as well as the structure and operation of various embodiments of the invention, are described in detail below with reference to the accompanying FIGS. 1-4, wherein like reference numerals refer to like elements.

Selenium is removed using a multi-stage system, comprising an up flow bioreactor, a downflow bioreactor and an optional membrane filtration step. Embodiments of the present invention provide anoxic bioreactors and biofilters using a media, on which to culture the biofilm. The upflow bioreactor media includes sand and/or granular activated carbon, or other media. While prior art selenium treatment systems focus on a single bioreactor configuration, they struggle with particulate retention and contribute to increased COD/BOD in the effluent. Embodiments of the present invention improve on this deficiency by including a configuration with an upflow bioreactor followed by a downflow biological filter followed by membrane filtration. This new configuration improves on the deficiencies of prior art by including a packed bed downflow filter that removes residual carbonaceous compounds (COD and BOD) and better removes particulate selenium. An optional membrane filter further removes residual fine precipitated elemental selenium from the effluent stream, as well as any particulate organic particles that are present.

FIG. 1 illustrates a multi-step system 100 for selenium removal according to an embodiment of the invention. The system 100 includes a feed water source 110 having selenium 115, an anoxic upflow bioreactor 120 having an output 120A, a packed bed downflow biofilter 130 having an output 130A, and a waste stream 130B, a membrane filtration step 140 producing a clean permeate stream 140A and a solids containing waste 140B, and a solids handling system 150. The system 100 removes selenium using the anoxic upflow bioreactor 120, the packed bed downflow bioreactor 130 (also referred to herein as a biofilter), and the membrane filtration step 140.

The feed water source 110 can be a river, pond, lake, another water source, or can be the output of an industrial device that may lead into a water source. The feed water source 110 may be mine runoff, coal-fired power plant effluents, or other anthropogenic or naturally occurring source. The feed water source 110 contains selenium 115.

The selenium 115 can be in various forms including selenate and selenite, both of which are dissolved and mobile forms that can be prevalent in water. Although the observed levels of selenium pollution are often not harmful for humans, these levels are at times toxic to fish and other wildlife.

The upflow bioreactor 120 is the first step in one embodiment. The anoxic bioreactor 120 receives the water having selenium 115 which attaches to biofilm media in the bioreactor 120. Unlike conventional bioreactors, the bioreactor 120 does not have to achieve selenium particulate removal, as this is achieved in the downstream downflow bioreactor 130 and the membrane filtration 140. This reduces the contact time required and the size of the bioreactor 120, compared to conventional systems that must achieve selenium precipitation and particulate removal in a single step.

Achieving selenium removal later in the downflow bioreactor 130, is not a trivial improvement because this allows for the upflow first stage's biological selenium reduction to be operated at a higher rate, as the solids removal and the filtration step is decoupled.

The upflow first stage operating at a “higher rate” means that the water flows through the system at a higher rate per bed surface area, typically quantified as gallon per minute/square foot. This flexibility allows the system to be optimized for gas removal, in a particular water chemistry, or water treatment setting. Gas formation rates are effected by water chemistry, temperature, bioreactor operating conditions, and the type of biofilm established in the bioreactor. Also, as most of the gas is formed in the upflow first stage, the downflow second stage will provide better filtration with the gas already removed, as the downflow second stage's bed will not be subject to gas bubbles forming, which create channels in the bed that hurt the filtration capability.

The second stage 130 will also be sized for near complete removal of residual nutrients formed from the first stage. This invention also allows the first stage to be run in an expanded mode. This is important for waters that have a high nitrate content, which results in high gas production due to the denitrification reaction. This invention concurrently solves the gas buildup problem and selenium particulate retention problems inherent with conventional systems and because the filters are much more effective at removing carbonaceous compounds and residual selenium.

The anoxic upflow bioreactor 120 biologically converts and removes contaminants from water by culturing a bacterial biofilm on an insoluble media support that is expanded by the up flow of water. Water comes in contact with the biofilm in the bioreactor 120, and the contaminants are reduced to a gaseous or solid form. The anoxic upflow bioreactor 120 contains biofilm media on which the bacteria community colonizes. The media can be granular activated carbon, 30-90 mesh silica, sand, or other media. The use of selected media in the anoxic bioreactor 120 provides high surface area for bacterial biofilm formation.

The anoxic upflow bioreactor 120 can be fed a carbon based nutrient that can be comprised of acetate, glucose, molasses, methanol, or other carbon source. This carbon based nutrient may be supplemented with phosphorus, nitrogen, and trace minerals.

The upflow bioreactor 120 can be a fluidized bed bioreactor, an expanded bed bioreactor, or a fixed bed bioreactor. A carbohydrate based nutrient mixture is dosed to this bioreactor and the bacteria within the bioreactor reduce the oxidized selenium to elemental selenium. The upflow configuration allows for gas evolution from the bed that forms due to bacterial respiration. The output 120A of the bioreactor 120 goes to the downflow filter 130.

The downflow bioreactor 130 treats the filterable selenium water outputted of the bioreactor 120. In one embodiment, the downflow biofilter 130 is a packed bed biological filter comprised of a granular activated carbon media. Biofilm attaches to the filtration media which aids in filtration and consumes the residual carbohydrate nutrient. The downflow, packed bed configuration allows for particulate removal to remove bacteria and particulate selenium. The downflow biological filter 130, and the upflow bioreactor 120, can be anaerobic and/or anoxic, which means they operate without the addition of supplemental air or oxygen.

The downflow biological filter 130 enables the use of downstream membrane treatment by removing carbonaceous compounds (COD and BOD) which contribute to membrane fouling, which is the plugging or blinding of the membrane pores, resulting in reduced permeability and flow through the membrane.

The output 130A of the biofilter 130 goes to the membrane filtration 140. Complete solids removal from the treated water stream 130A is not required, as the water from this step 130A is sent to the downstream membrane filtration step 140. The membrane filtration step 140 forces the water through a semi-permeable membrane with pressure.

The membrane filtration step 140 (e.g., membrane bioreactor, microfiltration filter, ultrafiltration filter) is a device of which is known by one with skill in the art. Although membrane filters are known in the art, the process of preparing the media such that it can be more easily filtered (production of filterable selenium) is novel. The combination of the upstream bioreactors (upflow followed by downflow) will effectively precipitate the selenium to a filterable form, and provide a water stream that has a BOD value of <10 mg/L, which is considered suitable for direct membrane filtration 140.

The membrane filtration step 140 may include membrane ultra-filtration or micro filtration. This membrane filtration step 140 is a barrier to retain and remove any particulate matter from the upstream processes 120, 130. All of these three units 120, 130, 140 run in an anoxic or anaerobic mode, that is, they operate without the addition of supplemental air or oxygen.

In the membrane filtration step 140, the membrane acts as a barrier and removes residual fine precipitated elemental selenium from the effluent stream. The membrane filtration step 140 removes, concentrates, and recovers any remaining particulates, measured as Total Suspended Solids. This filtration step is a barrier for particulate solids and allows for very high quality water to be discharged from the system. Particulate solids removed in this step may include bacteria, mineral solids, and precipitated particulate selenium.

In one embodiment, the filter 140 is an ultrafiltration membrane filter with a pore size from 0.1 to 0.001 microns. In another embodiment, the membrane filter 140 is a microfiltration membrane filter with a pore size of 0.1 to 3 microns. The membrane filter step produces a clean permeate stream 140A and a concentrate stream 140B. The output of the filter 140 is the effluent.

The effluent 140A is the clean effluent after the feed water treated for selenium removal in the invention. The term “effluent” refers to water suitable for surface discharge, as opposed to human drinking water. The clean water effluent 140A can flow into a river, ocean, lake, another water source, or can be the output of an industrial device that leads into a water source.

The filterable selenium waste stream 130B is water that has been treated by the upflow anoxic bioreactor 120 and the downflow biological filter 130, where the oxidized, soluble selenium has been converted to a filterable particulate selenium form. The downflow bioreactor 130 will retain produced solids, and will periodically be backwashed for cleaning. This waste stream 130B is sent to solids handling 150.

The filterable selenium waste stream 130B produced in the anoxic upflow bioreactor 120 is converted to a filterable solid form after the active biology on the media reacts with the dissolved selenium, precipitating it to particulate elemental selenium. As the anoxic upflow bioreactor 120 is a “living bioreactor”, bacteria multiply in the system and produce a biomass component as the selenium is produced. This elemental selenium may be incorporated with the biomass, resulting in production of a filterable and settleable selenium/biomass waste product. Therefore, dissolved selenium is removed from the water passing through the system. For example, the filterable selenium 130B can be incorporated into a settleable and sludge-like material containing sludge and media that is easier separated from the water phase in the solids handling system 150.

The waste stream 140B retains particulate selenium and other solids while the clean water can pass through the pores in the membrane 140. The waste stream 140B goes to the solids handling 150.

The solids handling step 150 may be a clarification system, a settling tank, or other apparatus designed to concentrate and separate solids from water. The solids handling system 150 receives selenium-containing solids from the outputs 130B of the downflow biofilter 130 and the membrane filtration waste 140B. These waste streams 130B, 140B contain biomass and particulate selenium in a concentrated form which can later be removed from the site for further processing or disposal.

Although not shown, the system 100 can have many other components known by those with skill in the art, to run and monitor all of the integrated components 120, 130, 140, 150. These components include meter probes for measurement of flow, pressure, and content, a mass transfer column, pumps, a computer system for controlling flow rate, flow control valves, pressure control valves, pressure indicator transmitters, gas removal, etc.

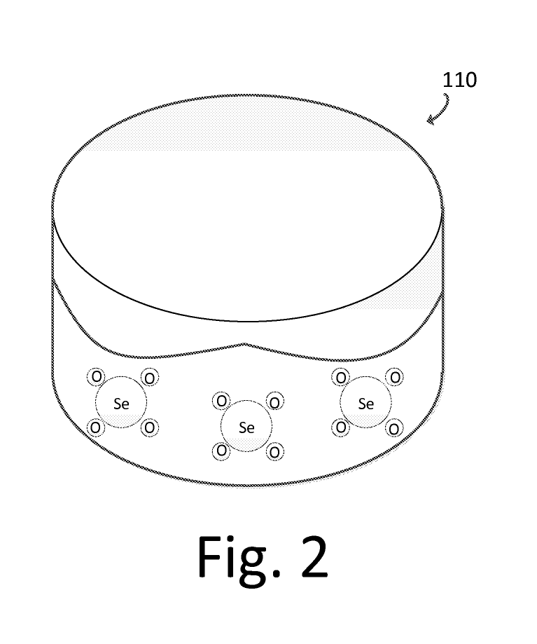

FIG. 2 illustrates the feed water source 110 of FIG. 1 according to an embodiment of the invention. The feed water source 110 is enlarged to show the selenate (SeO₄²⁻) illustrated as selenium and four oxygen atoms. These oxygen atoms can be removed by a gas stripping vacuum (not shown) prior to the water 110 entering the upflow bioreactor 120.

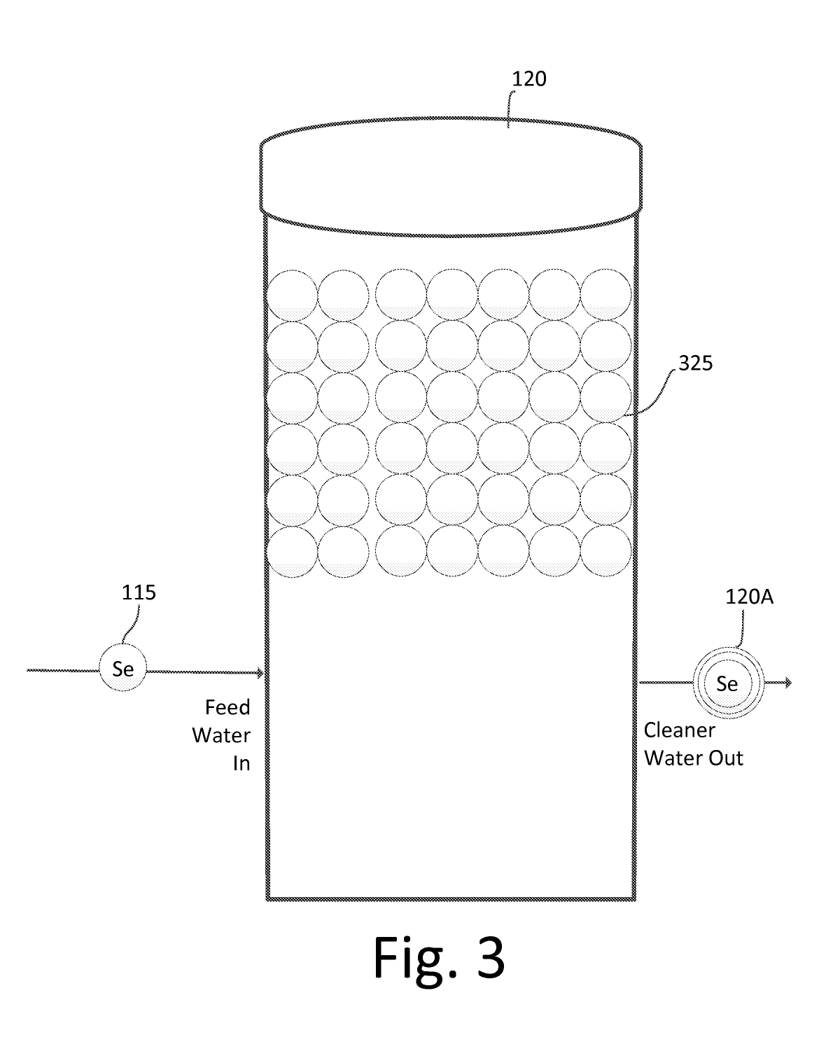

FIG. 3 illustrates the upflow bioreactor 120 of FIG. 1 according to an embodiment of the invention. The anaerobic fluidized bed bioreactor 120 receives feed water containing selenium 115. The selenium 115 forms discrete particles of filterable selenium which can also be outputted (not shown) to the solid handling 150. The bioreactor 120 has biofilm 325 to reacting with water to remove contaminants from the water. The bioreactor 120 outputs cleaner selenium 120A.

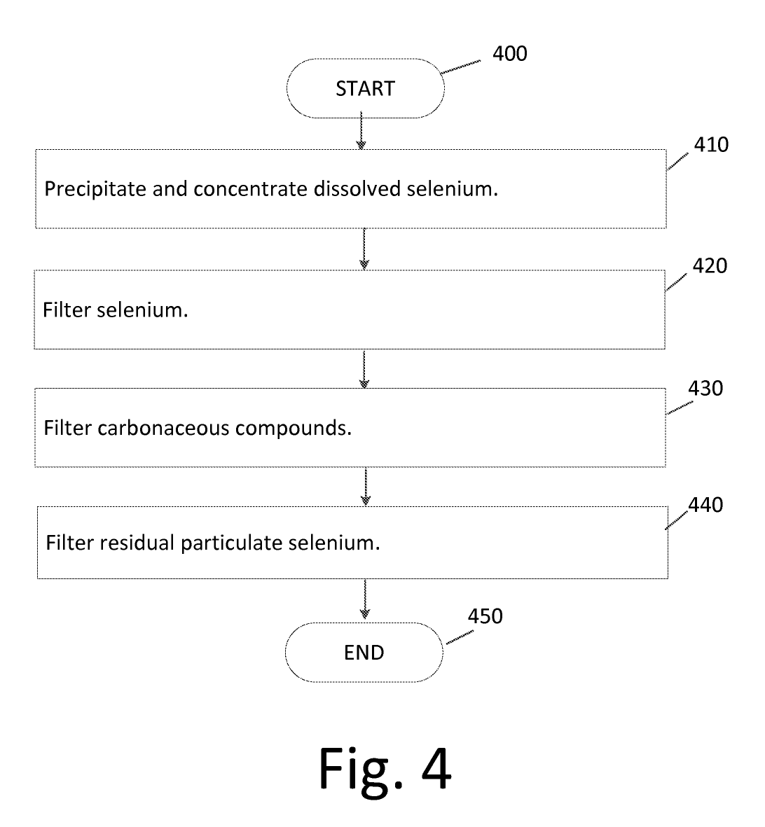

FIG. 4 illustrates the process of using the system according to an embodiment of the invention. The process starts at step 400. At step 410, the upflow fluidized bed bioreactor 120 removes selenium by precipitating dissolved selenium from water and concentrating into a filterable solid as solid waste. At step 420, the downflow biofilter 130 filters and collects selenium waste solids from the upflow bioreactor 120. At step 430, the downflow biofilter 130 removes carbonaceous compounds. At step 440, the membrane filter 140 removes the residual dissolved selenium and discharges clean water. The process ends at step 450.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments

What is claimed is:

1. A system comprising:
an upflow bioreactor having a bed, the upflow reactor configured to precipitate, concentrate, and biologically reduce dissolved selenium from water, wherein the water flows upwards in the upflow bioreactor, wherein the upward flow of water removes trapped gasses from the bed, wherein the upflow bioreactor creates carbonaceous compounds and particulate selenium in the water; and
a downflow bioreactor coupled to the upflow bioreactor, the downflow bioreactor configured to filter the carbonaceous compounds and configured to filter the particulate selenium.

2. The system of claim 1 further comprising a membrane filtration configured to filter the a residual particulate selenium remaining after the downflow bioreactor.

3. The system of claim 2, wherein the membrane filtration comprises microfiltration or ultrafiltration.

4. The system of claim 2, wherein the membrane filtration comprises reverse osmosis or nanofiltration.

5. The system of claim 1 further comprising a solids handling step coupled to the downflow bioreactor, wherein the solids handling step is configured to separate solids from water.

6. The system of claim 1 further comprising a feed water source coupled to an input of the upflow bioreactor.

7. The system of claim 1, wherein the water flows downwards in the downflow bioreactor.
